(19) United States
(12) Patent Application Publication
(10) Pub. No.: US 2009/0017827 A1
(43) Pub. Date: Jan. 15, 2009

(54) CONVENIENT USER RESPONSE TO WIRELESS CONTENT MESSAGES

(75) Inventors: Ron Perry, Bnei Zion (IL); Assaf Ben-Yossef, Givatayim (IL); Oz Levanon, Tel-Aviv (IL)

Correspondence Address: DARBY & DARBY P.C., P.O. BOX 770, Church Street Station, New York, NY, 10008-0770, US

(73) Assignee: Mobixell Networks Ltd., Ra'anana, IL (US)

(21) Appl. No.: 12/142,272

(22) Filed: Jun. 19, 2008

Related U.S. Application Data
(60) Provisional application No. 60/929,310, filed on Jun. 21, 2007.

(51) Int. Cl. H04Q 7/22; H04Q 7/20

(52) U.S. Cl. 455/445; 455/466

(57) ABSTRACT

A computer-implemented method is provided, including sending, to a plurality of mobile communication devices, respective messages that include respective message contents that differ from one another and respective human-readable instructions to dial a telephone number common to the messages. A telephone call placed to the telephone number is received from one of the mobile communication devices. One of the messages is identified as most recently sent to the one of the mobile communication devices. A call destination is selected responsively to the most recently sent one of the messages, and the telephone call is routed to the selected call destination. Other embodiments are also described.

### CROSS-REFERENCE TO RELATED APPLICATIONS

This application claims the benefit of U.S. Provisional Patent Application 60/929,310, filed Jun. 21, 2007, which is assigned to the assignee of the present patent application and whose disclosure is incorporated herein by reference.

### FIELD OF THE INVENTION

The present invention relates generally to mobile communication equipment, and specifically to methods and devices for initiating communication between a mobile communication device and a message content provider.

### BACKGROUND OF THE INVENTION

Wireless service providers often send multimedia messages with dynamic content to subscribers, and attempt to solicit a response to the messages. However, many mobile devices do not support hyperlinks or other automated techniques for subscribers to respond to the messages, which reduces the effectiveness of the messages.

U.S. Pat. No. 7,266,380 to Patel et al., which is incorporated herein by references describes a system and method for providing content to a mobile device in response to a marker received from the device and an associated context. A mobile device user initiates delivery of content or another action by entering the marker into the mobile device. The mobile device transmits the marker to a mobile network support system having a context server for supplying a context for the marker. The support system forms a message including the marker and context, and sends it to a content server. The content server uses the context to map the marker to a domain, retrieves from a content database the content identified by the marker and domain, and sends the content to the mobile network support system or performs another action with the content. The mobile network support system then transmits the content back to the mobile device.

US Patent Application Publication 2002/0022476 to Go, which is incorporated herein by reference, describes a method for using a screen of a cellular phone as a digital advertising medium to provide various kinds of advertisement data. The contents of the advertisements also include an advertiser's phone number for inquiries and web site address. The phone is able to dial the phone number and to access the web site automatically, and to buy a product or service if so desired. When such a request call is made, advertisement data registered in a database in a central telephone exchange office is edited and transmitted to the requester. Digital advertising contents are also stored in memory installed in the cellular phone. The stored advertisement contents are replayed on the phone screen by pushing pre-determined function keys.

### SUMMARY OF THE INVENTION

Embodiments of the present invention provide methods and systems for initiating communication between mobile communication devices and message content providers. In some embodiments, a plurality of message content providers send respective, different messages to respective mobile communication devices. The messages invite users of the devices to respond by initiating communication by entering into the device a sequence of characters that is common to all of the messages. The communication may be, for example, a voice (or voice-over-IP), video, or web communication session, or a message that includes at least text, such as a Short Message Service (SMS) message or a Multimedia Messaging Service (MMS) message. When a user responds to one of the messages, a response processor identifies which of the messages was most recently sent to the user's mobile device, and accordingly routes the communication initiated by the mobile device. The response processor routes the communication from the responding device to a destination associated with the content provider or operator of the response processor, or directs a web browser of the responding device to a web site associated with the content provider. Alternatively, the response processor routes the communication to a destination regardless of the which message was most recently sent to the device, and provides information indicative of the most recently sent message. The destination uses this information to appropriately respond to the communication.

The sequence of characters may comprise a telephone number, a Uniform Resource Locator (URL), or another telephony or network address specified in accordance with a communication protocol. The sequence of characters is typically short and easily remembered, such as a short telephone number (e.g., prefaced with an asterisk) or a short URL. The use of such an easily remembered sequence may be particularly important when the message comprises video content, because the user may forget the sequence of characters by the end of the video. In this manner, many content providers can share a single or small number of short and easily remembered telephone numbers and/or URLs, without requiring each content provider to register and maintain a unique, easily remembered telephone number or URL of its own, the supply of which may be limited.

In some embodiments of the present invention, a content provider sends a message embedded in a video stream to a mobile communication device that is equipped with streaming video capabilities. The message invites the user to submit a request for additional information by signaling via depressing the PAUSE and/or PLAY keys. The user request is registered and forwarded to the content provider, which initiates contact with the user after the conclusion of the video. This technique enables the submission of requests using nearly all video-capable mobile devices, even those that do not support the insertion of customizable links into video streams.

Embodiments of the present invention thus enable content providers to solicit responses to messages, such as advertisements or other promotion messages, from users using mobile communication devices that do not support hyperlinks or other automated techniques for responding to the messages. Because many mobile video players, and some Multimedia Messaging Service (MMS)-enabled devices, do not support hyperlinks or other clickable elements within multimedia content, users of these devices conventionally cannot conveniently respond to messages such as advertisements. Without such an ability to respond, such messages, particularly advertisements, are generally ineffective, and do not lead to viewer conversion. As a result, advertisers cannot readily measure advertisement effectiveness, and are generally unwilling to invest in sending such advertisements.

Embodiments of the present invention overcome these problems, and enable advertisers to conduct effective advertising campaigns with measurable results. In addition, the redirection of calls from the responding users to sales representatives provided by some embodiments of the present invention may result in increased rates of conversion-to-action. The techniques described herein are generally applicable to many types of advertisements, and may be particularly effective for impulse purchase orders. Typically, the advertising messages advertise respective products that are different from one another, and the products are marketed by respective business entities that are unaffiliated with one another.

There is therefore provided, in accordance with an embodiment of the present invention, a computer-implemented method including:

sending, to a plurality of mobile communication devices, respective messages that include respective message contents that differ from one another and respective human-readable instructions to dial a telephone number common to the messages;

receiving, from one of the mobile communication devices, a telephone call placed to the telephone number;

identifying one of the messages as most recently sent to the one of the mobile communication devices;

selecting a call destination responsively to the most recently sent one of the messages; and

routing the telephone call to the selected call destination.

Typically, the mobile communication devices are identified by respective unique device identifiers, and identifying the one of the messages as most recently sent includes identifying one of the device identifiers associated with the one of the mobile communication devices from which the call was placed, and identifying the one of the messages most recently sent to the one of the mobile communication devices identified by the one of the device identifiers.

Typically, receiving includes receiving the telephone call placed by manually entering the telephone number into the mobile communication device.

In an embodiment, the messages include initial messages, and including selecting a follow-up message responsively to the most recently sent one of the messages, and sending the follow-up message to the one of the of the mobile communication devices.

The messages may be advertising messages, and sending the respective messages may include sending the respective advertising messages. Typically, the advertising messages advertise respective products that are different from one another. The products are generally advertised by respective business entities that are unaffiliated with one another.

For some applications, the call destination is an automated response system. For other applications, the call destination is in a call center.

There is further provided, in accordance with an embodiment of the present invention, a computer-implemented method including:

sending, to a plurality of mobile communication devices, respective messages that include respective message contents that differ from one another and respective human-readable instructions to initiate communication by entering into the device a sequence of characters that is common to the messages;

receiving, from one of the mobile communication devices, the communication initiated at the device;

routing the communication to a destination; and

providing information indicative of which of the messages was most recently sent to the one of the mobile communication devices.

Typically, providing the information includes sending the information to the destination in association with the communication.

In an embodiment, the communication is a telephone call, receiving the communication includes receiving the telephone call, and routing includes routing the telephone call. For some applications, the destination is in a call center, and the call center uses the information to select a response to the telephone call. Alternatively, the destination is an automated response system, the telephone call includes an initial telephone call, and providing the information includes generating, responsively to information, a request for a call-back telephone call to the one of mobile communication devices.

For some applications, the messages are first messages, the communication is a second message that includes at least text, receiving the communication includes receiving the second message, and routing includes routing the second message. For some applications, the destination is an automated response system that generates a response responsively to the information.

Typically, receiving includes receiving the communication placed by manually entering the sequence of characters into the mobile communication device.

In an embodiment, the messages are advertising messages, and sending the respective messages includes sending the respective advertising messages. Typically, the advertising messages advertise respective products that are different from one another. The products are generally advertised by respective business entities that are unaffiliated with one another.

There is further provided, in accordance with an embodiment of the present invention, a computer-implemented method including:

sending, to a plurality of mobile communication devices, respective messages that include respective message contents that differ from one another and respective human-readable instructions to invoke a Uniform Resource Locator (URL) common to the messages, which URL specifies a first domain name;

receiving, from one of the mobile communication devices, an invocation of the URL;

identifying one of the messages as most recently sent to the one of the mobile communication devices;

responsively to the most recently sent one of the messages, selecting a webpage identified by a second domain name different from the first domain name; and

redirecting an Internet browser of the one of the mobile communication devices to the selected webpage.

Typically, the mobile communication devices are identified by respective unique device identifiers, and identifying the one of the messages as most recently sent includes identifying one of the device identifiers associated with the one of the mobile communication devices from which the URL was invoked, and identifying the one of the messages most recently sent to the one of the mobile communication devices identified by the one of the device identifiers.

Typically, receiving includes receiving the invocation of the URL caused by manually entering the URL into the mobile communication device.

In an embodiment, the messages include initial messages, and including selecting a follow-up message responsively to the most recently sent one of the messages, and sending the follow-up message to the one of the of the mobile communication devices.

For some applications, the webpage is an interstitial first webpage, and redirecting includes redirecting the Internet browser to the selected interstitial first webpage, and subsequently redirecting the browser to a second webpage identified by the URL.

The messages may be advertising messages, and sending the respective messages may include sending the respective advertising messages. Typically, the advertising messages advertise respective products that are different from one another. The products are generally advertised by respective business entities that are unaffiliated with one another.

There is still further provided, in accordance with an embodiment of the present invention, a computer-implemented method including:

sending, to a mobile communication device, a streaming video that includes a message and an invitation to respond to the message by depressing a sequence of one or more video control keys of the device;

receiving, from the mobile communication device, the sequence of one or more video control keys; and

initiating communication with the mobile communication device responsively to receiving the sequence.

For some applications, the sequence of one or more video control keys begins with a pause key. Optionally, the sequence includes, after the pause key, a key selected from the group consisting of: a play key and a resume key. For some applications, the sequence of one or more video control keys includes first and second depressions of a pause key, and initiating includes initiating the communication responsively to the first depression of the pause key, and the method further includes pausing the video stream responsively to the second depression of the pause key.

For some applications, initiating the communication includes inserting, into the video stream, an acknowledgement of receiving the sequence in response to the invitation.

For some applications, initiating the communication includes generating a request for initiating communication with the mobile communication device after completion of sending of the streaming video. Alternatively, the message is a first message, and initiating the communication includes transmitting a second message to the mobile communication device.

There is additionally provided, in accordance with an embodiment of the present invention, apparatus for use with a plurality of mobile communication devices, the apparatus including:

a mobile content server, configured to send, to the mobile communication devices, respective messages that include respective message contents that differ from one another and respective human-readable instructions to dial a telephone number common to the messages; and

a response processor, configured to receive, from one of the mobile communication devices, a telephone call placed to the telephone number, to identify one of the messages as most recently sent to the one of the mobile communication devices, to select a call destination responsively to the most recently sent one of the messages, and to route the telephone call to the selected call destination.

There is additionally provided, in accordance with an embodiment of the present invention, apparatus for use with a plurality of mobile communication devices, the apparatus including:

a mobile content server, configured to send, to a plurality of mobile communication devices, respective messages that include respective message contents that differ from one another and respective human-readable instructions to initiate communication by entering into the device a sequence of characters that is common to the messages; and

a response processor, configured to receive, from one of the mobile communication devices, the communication initiated at the device, route the communication to a destination, and provide information indicative of which of the messages was most recently sent to the one of the mobile communication devices.

There is yet additionally provided, in accordance with an embodiment of the present invention, apparatus for use with a plurality of mobile communication devices, the apparatus including:

a mobile content server, configured to send, to the mobile communication devices, respective messages that include respective message contents that differ from one another and respective human-readable instructions to invoke a Uniform Resource Locator (URL) common to the messages, which URL specifies a first domain name; and

a response processor, configured to receive, from one of the mobile communication devices, an invocation of the URL, to identify one of the messages as most recently sent to the one of the mobile communication devices, to select, responsively to the most recently sent one of the messages, a webpage identified by a second domain name different from the first domain name, and to redirect an Internet browser of the one of the mobile communication devices to the selected webpage.

There is also provided, in accordance with an embodiment of the present invention, apparatus for use with a mobile communication device, the apparatus including:

a video distribution system, configured to send, to the mobile communication device, a streaming video that includes a message and an invitation to respond to the message by depressing a sequence of one or more video control keys of the device and to receive, from the mobile communication device, the sequence of one or more video control keys; and

a registration manager, configured to initiate a communication with the mobile communication device responsively to receiving the sequence.

There is further provided, in accordance with an embodiment of the present invention, a computer software product for use with a plurality of mobile communication devices, the product including a tangible computer-readable medium in which program instructions are stored, which instructions, when read by a computer, cause the computer to send, to the mobile communication devices, respective messages that include respective message contents that differ from one another and respective human-readable instructions to dial a telephone number common to the messages, to receive, from one of the mobile communication devices, a telephone call placed to the telephone number, to identify one of the messages as most recently sent to the one of the mobile communication devices, to select a call destination responsively to the most recently sent one of the messages, and to route the telephone call to the selected call destination.

There is further provided, in accordance with an embodiment of the present invention, a computer software product for use with a plurality of mobile communication devices, the product including a tangible computer-readable medium in which program instructions are stored, which instructions, when read by a computer, cause the computer to send, to a plurality of mobile communication devices, respective messages that include respective message contents that differ from one another and respective human-readable instructions to initiate communication by entering into the device a sequence of characters that is common to the messages, receive, from one of the mobile communication devices, the communication initiated at the device, route the communication to a destination, and provide information indicative of which of the messages was most recently sent to the one of the mobile communication devices.

There is still further provided, in accordance with an embodiment of the present invention, a computer software product for use with a plurality of mobile communication devices, the product including a tangible computer-readable medium in which program instructions are stored, which instructions, when read by a computer, cause the computer to send, to the mobile communication devices, respective messages that include respective message contents that differ from one another and respective human-readable instructions to invoke a Uniform Resource Locator (URL) common to the messages, which URL specifies a first domain name, to receive, from one of the mobile communication devices, an invocation of the URL, to identify one of the messages as most recently sent to the one of the mobile communication devices, to select, responsively to the most recently sent one of the messages, a webpage identified by a second domain name different from the first domain name, and to redirect an Internet browser of the one of the mobile communication devices to the selected webpage.

There is additionally provided, in accordance with an embodiment of the present invention, a computer software product for use with a mobile communication device, the product including a tangible computer-readable medium in which program instructions are stored, which instructions, when read by a computer, cause the computer to send, to the mobile communication device, a streaming video that includes a message and an invitation to respond to the message by depressing a sequence of one or more video control keys of the device, to receive, from the mobile communication device, the sequence of one or more video control keys, and to initiate a communication with the mobile communication device responsively to receiving the sequence.

The present invention will be more fully understood from the following detailed description of the embodiments thereof, taken together with the drawings in which:

### BRIEF DESCRIPTION OF THE DRAWINGS

FIG. 1 is a schematic illustration of a wireless communication environment, in accordance with an embodiment of the present invention;

FIG. 2 is a schematic illustration of a mobile communication device, in accordance with an embodiment of the present invention;

FIG. 3 is a flow chart that schematically illustrates a method for initiating communication between a mobile communication device and a content provider, in accordance with an embodiment of the present invention;

FIG. 4 is a schematic illustration of another mobile communication device, in accordance with an embodiment of the present invention;

FIG. 5 is a schematic illustration of another wireless communication environment that supplies streaming video content to a user of a mobile communication device, in accordance with an embodiment of the present invention;

FIG. 6 is a schematic illustration of another mobile communication device, in accordance with an embodiment of the present invention; and

FIG. 7 is a flow chart that schematically illustrates a method for enabling a user to interactively respond to a content message embedded in a video stream, in accordance with an embodiment of the present invention.

### DETAILED DESCRIPTION OF EMBODIMENTS

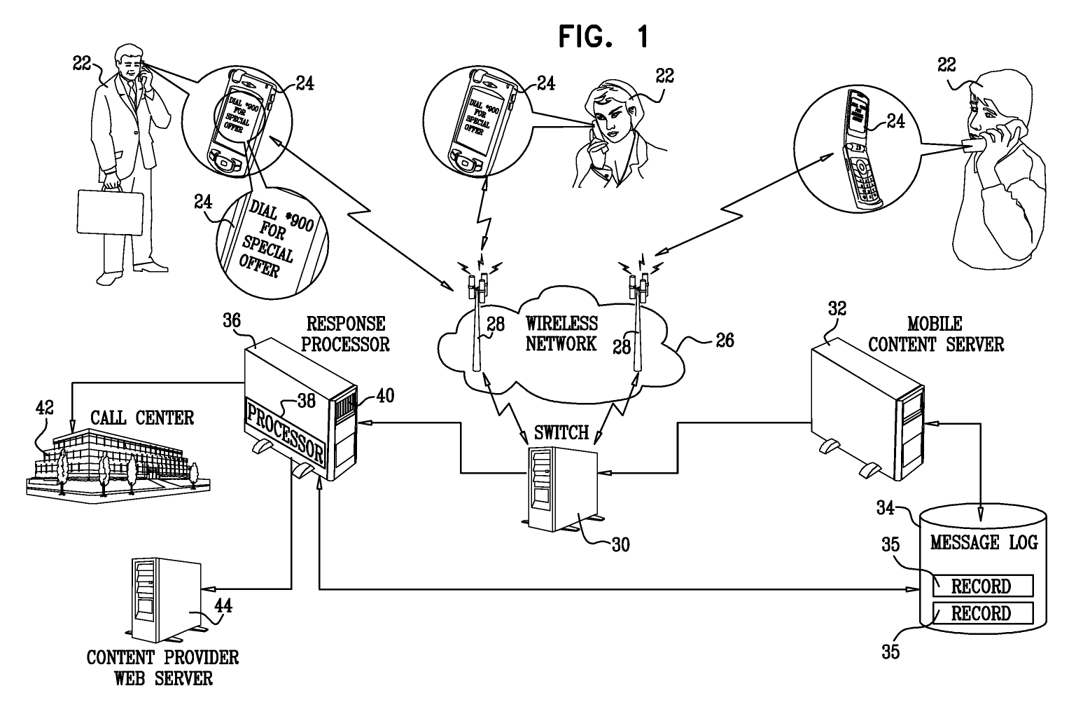

FIG. 1 is a schematic illustration of a wireless communication environment 20, in accordance with an embodiment of the present invention. A plurality of users 22 operate respective mobile communication devices 24, such as digital cellular telephones, wirelessly-enabled personal digital assistants (PDAs), two-way pagers, wirelessly-enabled handheld computers, or other wirelessly-enabled handheld computing devices. Mobile communication devices 24 are configured in hardware and/or software to receive and present multimedia content, such as video, audio, and/or text, and optionally may support Multimedia Messaging Service (MMS). Communication devices 24 are identified by respective unique device identifiers, such as MSISDNs in GSM-based cellular networks, or any other subscriber identifier used by mobile networks.

A wireless network 26 comprises one or more base stations 28, and at least one switching element 30, as is known in the cellular communication art. A mobile content server 32, which comprises at least one processor and an interface, generates messages, comprising video, voice, text, and/or data, and sends the messages to switch 30, which routes the messages to devices 24 via network 26. The message sending functions of content server 32 are typically implemented in software, which may be provided to the server in electronic form, over a network, for example, or it may alternatively be furnished on tangible media, such as optical, magnetic or electronic memory media. Content server 32 stores a log of the messages it sends, in a message log 34 comprising a plurality of message records 35. Record 35 comprises at least an identifier of the message and an identifier of the user (or device) to whom the message was sent. Message log 34 may comprise a database, such as a relational database, or may use any other suitable data structure. For some applications, as shown in FIG. 1, message log 34 is implemented on a standalone server, which comprises at least one processor, interface, and appropriate software for carrying out the logging function. Alternatively, message log 34 is implemented in mobile content server 32 or in response processor 36, which is described below (configurations not shown).

Some messages that content server 32 generates, such as advertisement or promotional messages, include human-readable instructions that invite users 22 to respond to the messages, such as by dialing a provided telephone number or by invoking a provided URL. In an embodiment of the present invention, the provided telephone number or URL is identical for a plurality of messages that have different content, for example, advertisements for different products and/or sent by different advertisers and/or unaffiliated corporate entities. For some applications, the provided telephone number comprises a limited number of characters (such as digits, letters, and/or symbols, e.g., the pound symbol or asterisk symbol), such as no more than 6 characters, or for example, no more than 4 characters, that is less than the number of characters generally included in full-length telephone numbers used to place a phone call in communication network 20. Alternatively or additionally, the provided telephone number may comprise a series of characters that users of the communication devices can both easily remember and/or quickly dial, such, as *900, or a number expressed using letters that spell a word or phrase, e.g., “MOREINFO.” For some applications, the provided URL comprises a series of characters that users of the communication devices can both easily remember and/or quickly invoke, such as www.info. Alternatively, the provided URL may be the URL of the portal of the operator of wireless network 26. The need for an easily remembered number (or URL) may be particularly important when the message comprises video content, because a long time may pass between presenting the number or URL to the user and when she actually dials when the video ends.

When one of users 22 responds to one of the messages, switch 30 routes the response to a response processor 36, which comprises at least one processor 38 and an interface 40. The response processing functions of response processor 36 are typically implemented in software, which may be provided to the response processor in electronic form, over a network, for example, or it may alternatively be furnished on tangible media, such as optical, magnetic or electronic memory media. For some applications, response processor 36 is implemented in switch 30 or mobile content server 32, rather than in a separate computer workstation. Response processor 36 accesses message log 34, typically by using the unique device identifier of the responding user, to retrieve at least a portion of the one of message records 35 corresponding to the message that content server 32 most recently sent to the responding user. (For applications in which message log 34 is implemented in mobile content server 32, as mentioned above, response processor 36 queries the mobile content server, which returns the at least a portion of the message record.)

In an embodiment of the present invention, in which the messages invite the users to dial a telephone number, the portion of message record 35 comprises a user or device identifier, and a message identifier. A redirection telephone number may be explicitly included in the record, or implicitly derived from the message identifier using another optional information source. Optionally, information regarding the respective message may be included as well. The information may comprise a summary of the message or the name or identifier code of a specific advertising campaign of which the message is a part. Response processor 36 redirects the incoming telephone call received from the responding user to the redirection telephone number, which terminates at a call center 42 or an automated response system. The call center or automated response system may be associated with the operator of response processor 36 or the content provider, and/or may be operated by a third party. Response processor 36 may also provide to call center 42 the information regarding the respective message, such as the specific message received by the user and/or the advertising campaign. Alternatively or additionally, message record 35 may comprise a follow-up message, such as a text message, e.g., a Short Message Service (SMS) message, a Multimedia Messaging Service (MMS) message, e-mail, or recorded voice message, that response processor 36 sends, or causes to be sent, to the responding user. For example, the follow-up message may include a URL. Further alternatively, message record 35 may comprise an indication to generate a request for a call-back telephone call, which request response processor 36 sends to call center 42, for example.

In another embodiment of the present invention, in which the messages invite the users to invoke a URL, the portion of message record 35 comprises an Internet (IP) address or a second URL, such as the address or URL of a webpage served by a content provider web server 44, to which response processor 36 redirects the Internet browser of the responding device. Typically, the IP address or second URL differs from the easily-remembered URL provided in the messages. Alternatively or additionally, the message record 35 may comprise a follow-up message, such as a text message (e.g., an SMS message), MMS message, e-mail, or recorded voice message, that response processor 36 sends, or causes to be sent, to the responding user. Further alternatively, message record 35 may comprise an indication to generate a request for a call-back telephone call, which request response processor 36 sends to call center 42, for example.

In yet another embodiment of the present invention, the messages invite the users to send a message including at least text, such as an SMS message, an MMS message, or an e-mail. Response processor 36 routes the message to an automated response system, which generates a response responsively to information indicative of the most recently received message, such as a request for a call-back and/or yet another message to the device.

The following table shows an exemplary set of message records 35 that response processor 36 accesses from message log 34:

TABLE 1

| Unique Device ID | Most Recently | Additional |
|---|---|---|
| (MSISDN format) | Sent Message ID | Information |
| 467011234567890 | Message #35: Free | Reroute to 455-6456 |
| | Bowling at Joe's | |
| 9720025555567890 | Message #64: | Ad campaign 1 |
| | Drinks on the | |
| | House at the Port | |
| | Front | |
| 0016312887029212 | Message #21: | Send SMS |
| | Mark's Root Beer | |
| | rules | |

In this exemplary table, each message record 35 is accessed via the unique device identifier of the responding device. The record comprises a message ID of the message most recently sent to the relevant device (and optionally a brief description of the message), as well as an optional additional information column (alternatively, the information in this column may be located in another table, which links message IDs to target actions), such as a telephone number to which response processor 36 routes telephone calls placed to the easily-remembered telephone number provided in the message. The implementation may include recording several messages with time stamps (in an additional column). If the user responses after a long delay the response processor (or call center representative) may ask him which of the last few presented messages interests him. Note that the additional information column may be implemented in a separate records table indexed for example by groups of messages.

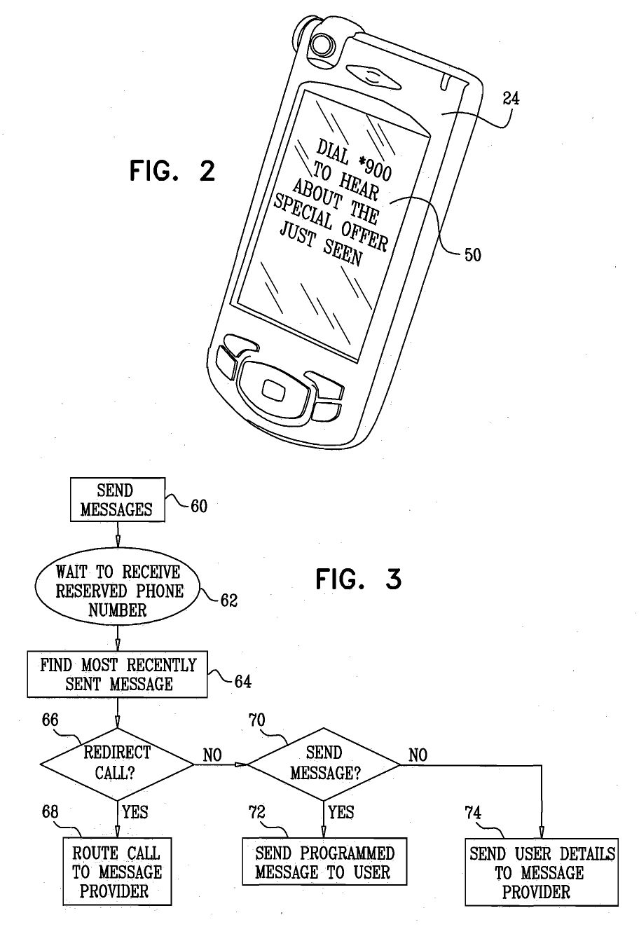

FIG. 2 is a schematic illustration of one of mobile communication devices 24, in accordance with an embodiment of the present invention. Device 24 invites user 22 (FIG. 1), via human-readable instructions 50, to respond to a received message by dialing a simple and easily dialed phone number, such as *900. For example, user 22 may elect to receive more information about an advertised product by speaking with a representative of the advertiser. For some applications, the message comprises video content, or another series of images, and instructions 50 are displayed after displaying the content, or as an overlay on the content.

FIG. 3 is a flow chart that schematically illustrates a method for initiating communication between a mobile communication device and a content provider. At a send message step 60, content server 32 sends to devices 24 a plurality of messages that invite users 22 to dial a reserved telephone number to respond to the messages, and logs the sending of the messages in respective records 35 in message log 34 (all elements shown in FIG. 1). At a wait step 62, response processor 36 waits for one of the users to dial the reserved telephone number. When one of the users dials the reserved telephone number, response processor 36 receives a telephone call from the user's mobile communication device. As used in the present application, including in the claims, a “telephone call” is any connection over a network that carries at least voice, and, optionally, video or other data. The network may comprise one or more wireless networks (such as wireless network 26), one or more circuit-switched networks (such as the public switched telephone network (PSTN)), and/or one or more packet-switched networks (such as an IP-based packet-switched network), such as a wireless packet-switched network or the Internet. The call may use an analog or digital protocol, e.g., a voice-over-IP protocol.

At a message location step 64, response processor 36 queries message log 34 to find the one of records 35 associated with the message that content server 32 most recently sent to the responding user. At a call redirect check step 66, response processor 36 checks whether record 35 indicates that the processor should route the incoming call from the responding user to call center 42. If the record indicates call redirection, response processor 36 routes the incoming call to the content provider at a call routing step 68.

If, on the other hand, the record does not indicate call redirection, response processor 36 checks at a send message check step 70 whether record 35 indicates that the processor should send a message to the responding user. If the record calls for the processor to send a message, response processor 36 sends a message to the responding user, at a send message step 72. If, on the other hand, the record does not indicate that the response processor should send a message, the response processor supplies details of the responding user, such as the unique identification number, to the content provider at a user detail provision step 74. Optionally, response processor 36 may proceed from call routing step 68 to user detail provision step 74 in order to supply the content provider with additional information about the responding user.

For some applications, response processor 36 is configured to proceed directly from message location step 64 to call routing step 68, without performing the check at call redirect check step 66. Similarly, for some applications, the response processor is configured to proceed directly from message location step 64 to send message step 72, without performing the check at send message check step 70.

For some applications, message records 35 additionally include a timestamp indicating when each message was sent to the recipient. In such cases, modules further down the chain (e.g., call center 42) can make decisions based on a history of messages sent to the user. For example, if the user responds after a long delay, the call center representative may, during the dialog with the subscriber, be presented with the message history for this specific user, and accordingly ask her which message interests her.

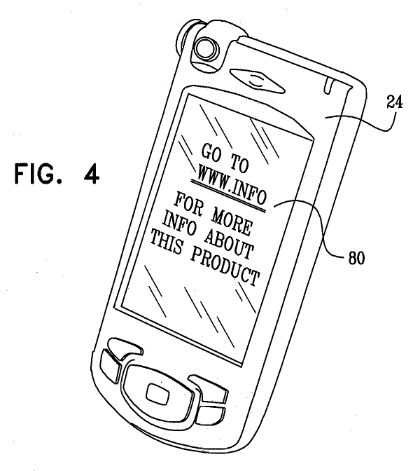

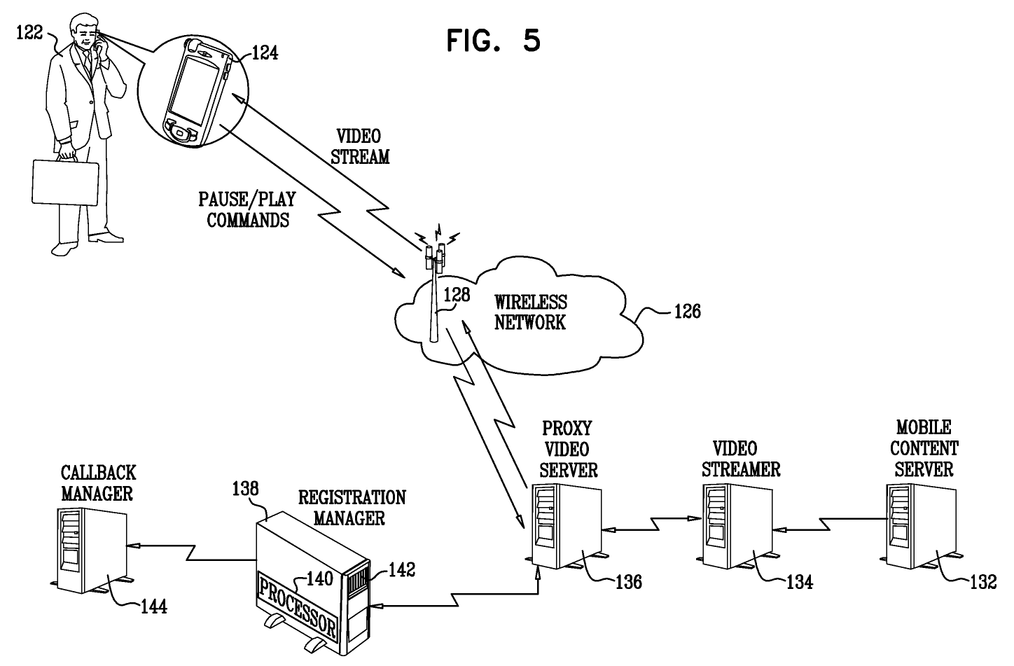

FIG. 4 is a schematic illustration of one of mobile communication devices 24, in accordance with an embodiment of the present invention. Device 24 invites user 22 (FIG. 1), via human-readable instructions 80, to respond to a received message by invoking a simple and easily input URL, such as www.info. For example, user 22 may elect to receive more information about an advertised product by browsing the web site of the advertiser. For some applications, the message comprises video content, or another series of images, and instructions 80 are displayed after displaying the content, or as an overlay on the content.

Reference is again made to FIG. 3. The method described with reference to FIG. 3 is appropriately modified for embodiments in which the message invites the user to invoke a provided URL, instead of dialing a provided telephone number. At wait step 62, response processor 36 waits for a user to invoke the reserved URL, and at call routing step 68, the response processor redirects the Internet browser of the responding user to the second URL or IP address found in the message log record instruction. For some applications, such as if the reserved URL is of the portal of the operator of wireless network 26, at call routing step 68 the response processor redirects the Internet browser only if the user invokes the reserved URL within a threshold period of time after receiving the message, such as within five minutes of receiving the message.

In an embodiment of the present invention, a web server hosting the provided URL serves an interstitial webpage (typically clickable) selected responsively to the message most recently sent to the user. If the user does not click on the interstitial, the user is redirected to the webpage associated with the provided URL. In this embodiment, the provided URL is not necessarily included in the message. For example, the interstitial may be displayed whenever the user visits the portal of the operator of wireless network 26 within a threshold period of time after receiving a message from mobile content server 32.

FIG. 5 is a schematic illustration of a wireless communication environment 120 that supplies streaming video content to at least one user 122 of a mobile communication device 124, in accordance with an embodiment of the present invention. A wireless network 126 comprises one or more base stations 128, as is known in the cellular communication art. A video distribution system comprises a mobile content server 132, which comprises at least one processor and interface, a video streamer 134, which also comprises at least one processor and interface, and, optionally, a proxy video server 136, comprising at least one processor and interface. Mobile content server 132 provides a video content message, such as a multimedia advertisement, to video streamer 134, which streams the content message to device 124, typically via proxy video server 136. The proxy video server and the video streamer may be implemented as a single unit.

Device 124 and proxy server 136 communicate using a streaming video protocol, such as Real Time Streaming Protocol (RTSP), which enables device 124 to pause and to resume the video stream, typically by depressing keys on the device keypad that generate commands to proxy video server 136. The pause and resume commands are sent by RTSP from the proxy server to the video streamer to perform the actual operation.

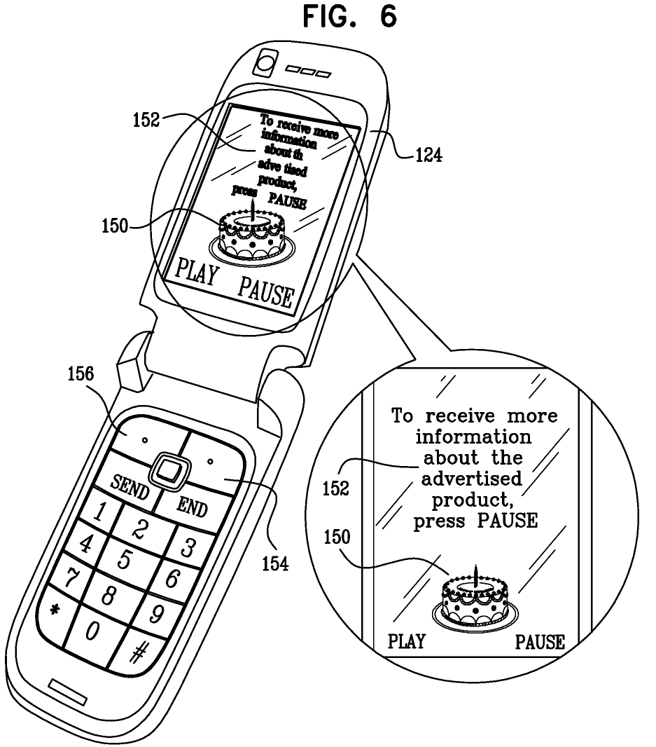

In this embodiment, video streamer 134 inserts at one or more points in the content message at least one invitation to user 122 to respond to the message by depressing a response sequence of one or more conventional video control keys, such as the PAUSE, PLAY, or RESUME keys (which are typically soft keys). The response to the message may, for example, request more information about a product advertised in the message. The video distribution system uses these conventional control keys for signaling a response to the invitation. The system typically identifies the signaling sequence by the order of the depressed keys and the time between depressions, and/or the timing of the depressed keys with respect to the presentation of the invitation. For example, the system may interpret depression of control keys as indicative of a response to the invitation only if the depression occurs within a threshold period of time after the device presents the invitation. Typically, the video streamer inserts the invitation as a textual overlay of the video content, as described hereinbelow with reference to FIG. 6. Other multimedia invitation alternative messages are within the scope of the present invention, such as by image, video, or audio.

Exemplary invitations include, but are not limited to:
“Press PAUSE and PLAY right now to receive more information”;
“Press PAUSE and RESUME right now to receive more information”;
“Press PAUSE right now to receive more information”;
“Press PAUSE twice right now to receive more information”;
“Press PLAY right now to receive more information.”
   In the first example, the video streamer receives an RTSP “play” command from the mobile device when the user resumes the video.

For some applications, upon receiving the pause command, proxy server 136 instructs video streamer 134 to pause the video stream to device 124, while for other applications, the proxy server does not instruct video streamer 134 to pause the video stream, i.e., the depression of the pause key serves only for signaling a response to the invitation. In these latter applications, in order for user 122 to pause the video stream, the user must depress the pause key a second time. Proxy server 136 transmits the second pause command to video streamer 134, which pauses the video stream to the device.

For some applications, the video message includes more than one invitation, and the video streamer identifies the location within the video at which the user generates the response sequence, in order to identify the invitation to which the user is responding, based on the timing of the invitation and response.

When proxy server 136 receives the response sequence, the proxy server notifies a registration manager 138, comprising at least one processor 140 and an interface 142, of the unique identifier of the device in addition to an identifier of the video content to which the device responded, for example, the specific advertising campaign. For some applications, proxy server 136 or video streamer 134 insert into the video stream an acknowledgement of receipt of the user response, for example, “Your request has been received; you will be contacted shortly.” Additionally or alternatively, proxy server 136 may instruct the video streamer 134 to stop the video stream to device 124 upon reception of the response sequence.

In an embodiment of the present invention, video streamer 134 informs registration manager 138 when the streamer has completed sending the message, and the registration manager passes to a callback manager 144 the unique identifier of the responding device and the relevant content identifier. Callback manager 144 initiates communication with device 124, such as initiating a phone call-back to device 124, or sending a message, for example an SMS or MMS, to device 124 that includes additional details about the video content. For some applications, this post-video communication is not performed. In these applications, inserting the acknowledgement into the video stream, as described above, may be the only communication initiated with the device responsively to the request. For some applications, the system performs an additional operation responsively to the request, such as registering the user in a lottery. Optionally, the system does not initiate communication with the device responsively to receiving the request.

FIG. 6 is a schematic illustration of mobile communication device 124, in accordance with an embodiment of the present invention. Device 124 displays a video content 150, such as an advertisement, and a textual overlay 152, which invites user 122 to pause the video to receive more information, for example, about the advertised product. Device 124 comprises a pause key 154 and a play key 156. Typically, device 124 does not comprise dedicated pause and play keys on the device keypad, and the device display indicates which keys on the keypad serve as pause key 154 and play key 156 when viewing video content. Alternatively, device 124 may comprise dedicated keys that serve as pause and play keys, respectively.

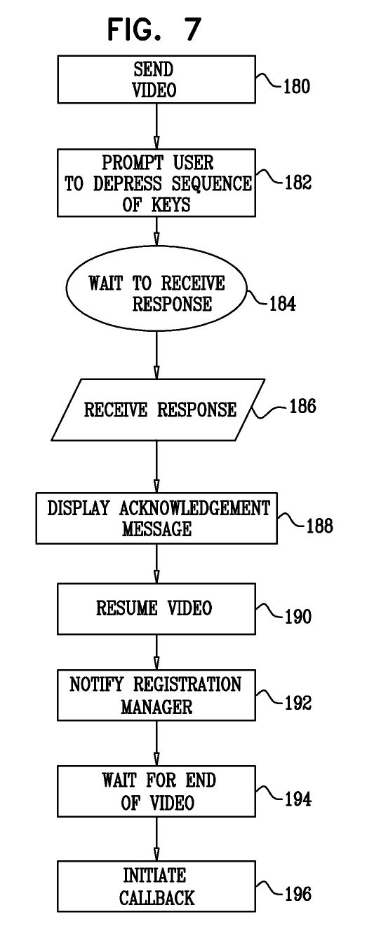

FIG. 7 is a flow chart that schematically illustrates a method for enabling user 122 to interactively respond to a content message embedded in a video stream, in accordance with an embodiment of the present invention. At a send video step 180, video streamer 134 begins streaming to device 124 a video that includes embedded message content. At a user prompt step 182, the video prompts user 122 to depress a sequence of one or more keys to respond to the message content, for example to request to be contacted by the content provider. Proxy server 136 waits for user 122 to depress the response sequence, at a wait-for-response step 184. At a response sequence reception step 186, proxy server 136 receives the response sequence from device 124. At an optional acknowledgement message display step 188, registration manager 138 requests from video streamer 134 to generate and send to user 122 an acknowledgement message, as described hereinabove with reference to FIG. 5. Video streamer 134 resumes sending the message to user 122, at an optional video resumption step 190. Step 190 is required when the stream was actually paused. If step 190 is not performed, video streamer 134 ceases sending the message to the user responsively to receiving the request at step 186.

At a registration manager notification step 192, proxy server 136 indicates to registration manager 138 that user 122, identified by his or her unique identification number, has responded to the video message. At a video termination waiting step 194, registration manager 138 waits for video streamer 134 to report that the video message has terminated. At a callback initiation step 196, callback manager 144 initiates communication with user 122 either by sending a message or generating a request to initiate a telephone call to user 122. For some applications, steps 192 through 196 are not performed.

It will be appreciated by persons skilled in the art that the present invention is not limited to what has been particularly shown and described hereinabove. Rather, the scope of the present invention includes both combinations and subcombinations of the various features described hereinabove, as well as variations and modifications thereof that are not in the prior art, which would occur to persons skilled in the art upon reading the foregoing description.

1. A computer-implemented method comprising:
sending, to a plurality of mobile communication devices, respective messages that include respective message contents that differ from one another and respective human-readable instructions to dial a telephone number common to the messages;
receiving, from one of the mobile communication devices, a telephone call placed to the telephone number;
identifying one of the messages as most recently sent to the one of the mobile communication devices;
selecting a call destination responsively to the most recently sent one of the messages; and
routing the telephone call to the selected call destination.

2. The method according to claim 1, wherein the mobile communication devices are identified by respective unique device identifiers, and wherein identifying the one of the messages as most recently sent comprises identifying one of the device identifiers associated with the one of the mobile communication devices from which the call was placed, and identifying the one of the messages most recently sent to the one of the mobile communication devices identified by the one of the device identifiers.

3. The method according to claim 1, wherein receiving comprises receiving the telephone call placed by manually entering the telephone number into the mobile communication device.

4. The method according to claim 1, wherein the messages comprise initial messages, and comprising selecting a follow-up message responsively to the most recently sent one of the messages, and sending the follow-up message to the one of the of the mobile communication devices.

5. The method according to claim 1, wherein the messages are advertising messages, and wherein sending the respective messages comprises sending the respective advertising messages.

6. The method according to claim 5, wherein the advertising messages advertise respective products that are different from one another.

7. The method according to claim 6, wherein the products are advertised by respective business entities that are unaffiliated with one another.

8. The method according to claim 1, wherein the call destination is an automated response system.

9. The method according to claim 1, wherein the call destination is in a call center.

10. A computer-implemented method comprising:
sending, to a plurality of mobile communication devices, respective messages that include respective message contents that differ from one another and respective human-readable instructions to initiate communication by entering into the device a sequence of characters that is common to the messages;
receiving, from one of the mobile communication devices, the communication initiated at the device;
routing the communication to a destination; and
providing information indicative of which of the messages was most recently sent to the one of the mobile communication devices.

11. The method according to claim 10, wherein providing the information comprises sending the information to the destination in association with the communication.

12. The method according to claim 10, wherein the communication is a telephone call, wherein receiving the communication comprises receiving the telephone call, and wherein routing comprises routing the telephone call.

13. The method according to claim 12, wherein the destination is in a call center, and wherein the call center uses the information to select a response to the telephone call.

14. The method according to claim 12, wherein the destination is an automated response system, wherein the telephone call comprises an initial telephone call, and wherein providing the information comprises generating, responsively to information, a request for a call-back telephone call to the one of mobile communication devices.

15. The method according to claim 10, wherein the messages are first messages, wherein the communication is a second message that includes at least text, wherein receiving the communication comprises receiving the second message, and wherein routing comprises routing the second message.

16. The method according to claim 10, wherein the destination is an automated response system that generates a response responsively to the information.

17. The method according to claim 10, wherein receiving comprises receiving the communication placed by manually entering the sequence of characters into the mobile communication device.

18. The method according to claim 10, wherein the messages are advertising messages, and wherein sending the respective messages comprises sending the respective advertising messages.

19. The method according to claim 10, wherein the advertising messages advertise respective products that are different from one another.

20. The method according to claim 10, wherein the products are advertised by respective business entities that are unaffiliated with one another.

21. A computer-implemented method comprising:
sending, to a plurality of mobile communication devices, respective messages that include respective message contents that differ from one another and respective human-readable instructions to invoke a Uniform Resource Locator (URL) common to the messages, which URL specifies a first domain name;
receiving, from one of the mobile communication devices, an invocation of the URL;
identifying one of the messages as most recently sent to the one of the mobile communication devices;
responsively to the most recently sent one of the messages, selecting a webpage identified by a second domain name different from the first domain name; and
redirecting an Internet browser of the one of the mobile communication devices to the selected webpage.

22. The method according to claim 21, wherein the mobile communication devices are identified by respective unique device identifiers, and wherein identifying the one of the messages as most recently sent comprises identifying one of the device identifiers associated with the one of the mobile communication devices from which the URL was invoked, and identifying the one of the messages most recently sent to the one of the mobile communication devices identified by the one of the device identifiers.

23. The method according to claim 21, wherein receiving comprises receiving the invocation of the URL caused by manually entering the URL into the mobile communication device.

24. The method according to claim 21, wherein the messages comprise initial messages, and comprising selecting a follow-up message responsively to the most recently sent one of the messages, and sending the follow-up message to the one of the of the mobile communication devices.

25. The method according to claim 21, wherein the webpage is an interstitial first webpage, and wherein redirecting comprises redirecting the Internet browser to the selected interstitial first webpage, and subsequently redirecting the browser to a second webpage identified by the URL.

26. The method according to claim 21, wherein the messages are advertising messages, and wherein sending the respective messages comprises sending the respective advertising messages.

27. The method according to claim 26, wherein the advertising messages advertise respective products that are different from one another.

28. The method according to claim 27, wherein the products are advertised by respective business entities that are unaffiliated with one another.

29. A computer-implemented method comprising:
sending, to a mobile communication device, a streaming video that includes a message and an invitation to respond to the message by depressing a sequence of one or more video control keys of the device;
receiving, from the mobile communication device, the sequence of one or more video control keys; and
initiating communication with the mobile communication device responsively to receiving the sequence.

30. The method according to claim 29, wherein the sequence of one or more video control keys begins with a pause key.

31. The method according to claim 30, wherein the sequence includes, after the pause key, a key selected from the group consisting of: a play key and a resume key.

32. The method according to claim 29, wherein the sequence of one or more video control keys includes first and second depressions of a pause key, and wherein initiating comprises initiating the communication responsively to the first depression of the pause key, and comprising pausing the video stream responsively to the second depression of the pause key.

33. The method according to claim 29, wherein initiating the communication comprises inserting, into the video stream, an acknowledgement of receiving the sequence in response to the invitation.

34. The method according to claim 29, wherein initiating the communication comprises generating a request for initiating the communication with the mobile communication device after completion of sending of the streaming video.

35. The method according to claim 29, wherein the message is a first message, and wherein initiating the communication comprises transmitting a second message to the mobile communication device.

36. Apparatus for use with a plurality of mobile communication devices, the apparatus comprising:
a mobile content server, configured to send, to the mobile communication devices, respective messages that include respective message contents that differ from one another and respective human-readable instructions to dial a telephone number common to the messages; and
a response processor, configured to receive, from one of the mobile communication devices, a telephone call placed to the telephone number, to identify one of the messages as most recently sent to the one of the mobile communication devices, to select a call destination responsively to the most recently sent one of the messages, and to route the telephone call to the selected call destination.

37. The apparatus according to claim 36, wherein the messages are advertising messages that advertise respective products that are different from one another, and wherein the mobile content server is configured to send the respective advertising messages.

38. Apparatus for use with a plurality of mobile communication devices, the apparatus comprising:
a mobile content server, configured to send, to a plurality of mobile communication devices, respective messages that include respective message contents that differ from one another and respective human-readable instructions to initiate communication by entering into the device a sequence of characters that is common to the messages; and
a response processor, configured to receive, from one of the mobile communication devices, the communication initiated at the device, route the communication to a destination, and provide information indicative of which of the messages was most recently sent to the one of the mobile communication devices.

39. The apparatus according to claim 38, wherein the response processor is configured to send the information to the destination in association with the communication.

40. The apparatus according to claim 38, wherein the communication is a telephone call, and wherein the response processor is configured to receive and route the telephone call.

41. The apparatus according to claim 38, wherein the messages are first messages, wherein the communication is a second message that includes at least text, and wherein the response processor is configured to receive and route the second message.

42. The apparatus according to claim 38, wherein the messages are advertising messages that advertise respective products that are different from one another, and wherein the mobile content server is configured to send the respective advertising messages.

43. Apparatus for use with a plurality of mobile communication devices, the apparatus comprising:
a mobile content server, configured to send, to the mobile communication devices, respective messages that include respective message contents that differ from one another and respective human-readable instructions to invoke a Uniform Resource Locator (URL) common to the messages, which URL specifies a first domain name; and
a response processor, configured to receive, from one of the mobile communication devices, an invocation of the URL, to identify one of the messages as most recently sent to the one of the mobile communication devices, to select, responsively to the most recently sent one of the messages, a webpage identified by a second domain name different from the first domain name, and to redirect an Internet browser of the one of the mobile communication devices to the selected webpage.

44. The apparatus according to claim 43, wherein the webpage is an interstitial first webpage, and wherein the response processor is configured to redirect the Internet browser to the selected interstitial first webpage, and subsequently redirect the browser to a second webpage identified by the URL.

45. The apparatus according to claim 43, wherein the messages are advertising messages that advertise respective products that are different from one another, and wherein the mobile content server is configured to send the respective advertising messages.

46. Apparatus for use with a mobile communication device, the apparatus comprising:
a video distribution system, configured to send, to the mobile communication device, a streaming video that includes a message and an invitation to respond to the message by depressing a sequence of one or more video control keys of the device and to receive, from the mobile communication device, the sequence of one or more video control keys; and
a registration manager, configured to initiate communication with the mobile communication device responsively to receiving the sequence.

47. The apparatus according to claim 46, wherein the sequence of one or more video control keys begins with a pause key.

48. The apparatus according to claim 47, wherein the sequence includes, after the pause key, a key selected from the group consisting of: a play key and a resume key.

49. The apparatus according to claim 46, wherein the sequence of one or more video control keys includes first and second depressions of a pause key, wherein the registration manager is configured to initiate the communication responsively to the first depression of the pause key, and wherein the video distribution system is configured to pause the video stream responsively to the second depression of the pause key.

50. The apparatus according to claim 46, wherein the registration manager is configured to initiate the communication by generating a request for initiating communication with the mobile communication device after completion of sending of the streaming video.

51. The apparatus according to claim 46, wherein the message is a first message, and wherein the registration manager is configured to initiate the communication by transmitting a second message to the mobile communication device.

52. A computer software product for use with a plurality of mobile communication devices, the product comprising a tangible computer-readable medium in which program instructions are stored, which instructions, when read by a computer, cause the computer to send, to the mobile communication devices, respective messages that include respective message contents that differ from one another and respective human-readable instructions to dial a telephone number common to the messages, to receive, from one of the mobile communication devices, a telephone call placed to the telephone number, to identify one of the messages as most recently sent to the one of the mobile communication devices, to select a call destination responsively to the most recently sent one of the messages, and to route the telephone call to the selected call destination.

53. A computer software product for use with a plurality of mobile communication devices, the product comprising a tangible computer-readable medium in which program instructions are stored, which instructions, when read by a computer, cause the computer to send, to a plurality of mobile communication devices, respective messages that include respective message contents that differ from one another and respective human-readable instructions to initiate communication by entering into the device a sequence of characters that is common to the messages, receive, from one of the mobile communication devices, the communication initiated at the device, route the communication to a destination, and provide information indicative of which of the messages was most recently sent to the one of the mobile communication devices.

54. A computer software product for use with a plurality of mobile communication devices, the product comprising a tangible computer-readable medium in which program instructions are stored, which instructions, when read by a computer, cause the computer to send, to the mobile communication devices, respective messages that include respective message contents that differ from one another and respective human-readable instructions to invoke a Uniform Resource Locator (URL) common to the messages, which URL specifies a first domain name, to receive, from one of the mobile communication devices, an invocation of the URL, to identify one of the messages as most recently sent to the one of the mobile communication devices, to select, responsively to the most recently sent one of the messages, a webpage identified by a second domain name different from the first domain name, and to redirect an Internet browser of the one of the mobile communication devices to the selected webpage.

55. A computer software product for use with a mobile communication device, the product comprising a tangible computer-readable medium in which program instructions are stored, which instructions, when read by a computer, cause the computer to send, to the mobile communication device, a streaming video that includes a message and an invitation to respond to the message by depressing a sequence of one or more video control keys of the device, to receive, from the mobile communication device, the sequence of one or more video control keys, and to initiate communication with the mobile communication device responsively to receiving the sequence.
